(19) United States
(12) Patent Application Publication
(10) Pub. No.: US 2014/0040171 A1
(43) Pub. Date: Feb. 6, 2014

(54) CONTENT-BASED DEMOGRAPHIC ESTIMATION OF USERS OF MOBILE DEVICES AND USAGE THEREOF

(71) Applicant: TRIAPODI LTD, Herzlia, IL (US)

(72) Inventors: Yaron Segalov, Tel-Aviv (IL); Amir Maor, Tel-Aviv (IL)

(73) Assignee: TRIAPODI LTD, Herzlia (IL)

(21) Appl. No.: 13/644,878

(22) Filed: Oct. 4, 2012

Related U.S. Application Data
(60) Provisional application No. 61/677,661, filed on Jul. 31, 2012.

(51) Int. Cl. G06F 15/173; G06F 15/18

(52) U.S. Cl. 706/12; 709/224

(57) ABSTRACT

Method, apparatus and product for content-based demographic estimation of users of mobile devices and usage thereof. One method comprising: obtaining a list of applications that are installed on a mobile device; and estimating, based on the list of applications, one or more demographic parameter of a user of the mobile device. Another method, that is performed by a mobile device, comprising: obtaining a list of applications that are installed on said mobile device, wherein based on the list of applications, one or more demographic parameters of a user of said mobile device are determined; and performing a user engagement based on the estimated one or more demographic parameters.

### CROSS-REFERENCE TO RELATED APPLICATION

This application claims the benefit of U.S. Provisional Application No. 61/677,661 filed Jul. 31, 2012, which is hereby incorporated by reference in its entirety.

### TECHNICAL FIELD

The present disclosure relates generally to mobile devices and, more particularly to prediction and estimation of demographic information relating to the users of the mobile devices.

### BACKGROUND

A mobile device, such as a Personal Digital Assistant (PDA), a tablet computer, an e-book reader, a smart phone, or similar computerized device is commonly used by the public.

A user may install applications (also referred to as “apps”) on the mobile device. The apps may be obtained from a repository, such as a free app repository, an online store, or the like. While the user may also install apps from different sources, most users may obtain their apps from a common source: the repository. One example of such repository is Apple™'s AppStore™ from which most user's download apps to their iPhone™ and iPad™ devices. Another example, is Google™'s Play™ from which most user's download apps to their smart phones or tablets that use the Android™ Operating System.

Determining demographic parameters of a user of the mobile device may be useful for performing user engagements, such as but not limited to targeting content to the user, such as advertisements, recommendations, content filtering, or the like. Additional user engagements in the mobile device may User Interface (UI) manipulation such as modifying color scheme of the UI, language and wording selection, or the like.

Demographic information may comprise demographic parameters such as, but not limited to, gender, race, age or age group, disabilities, mobility, home ownership, employment status, location, annual income, or the like.

Applications of the mobile device may obtain the demographic parameters from the user by explicitly requesting the user to fill-in demographic information. Additionally or alternatively, based on the user's demographic information in an online service to which the application is connected, the information may be obtained. The user may be simply required to log-in into the online service, and allow the application to access his private data retained in the online service. The online service may be, for example, a social network (e.g., Facebook™, Google+™ and LinkedIn™), an email service, or the like. Such applications may be referred to as demographic-aware applications.

### BRIEF SUMMARY

One exemplary embodiment of the disclosed subject matter is a computer-implemented method performed by a processing unit, said method comprising: obtaining a list of applications that are installed on a mobile device; and estimating, based on the list of applications, one or more demographic parameter of a user of the mobile device.

Optionally, the applications are downloadable applications, and wherein the applications are listed in an electronic catalog.

Optionally, the electronic catalog is associated with a mobile applications repository connectable over a computerized network.

Optionally, said obtaining comprises receiving from the mobile device the list of applications, and wherein said estimating is performed by a server comprising said processing unit, wherein the server is connectable via a network to the mobile device.

Optionally, the method further comprises obtaining usage statistics associated with the applications, and wherein said estimating is further based on the usage statistics.

Optionally, the usage statistics comprising at least one of the following information: installation time; order of installation; usage count; and last usage time.

Optionally, the method further comprises obtaining non-application data, and wherein said estimating is further based on the non-application data.

Optionally, the non-application data comprises at least one of the following items: statistics relating to non-application content in the mobile device; meta-data obtainable from digital files retained in the mobile device; a number of media files retained in the mobile device; one or more types of media files retained in the mobile device; origin of media files retained in the mobile device; and information relating to the mobile device.

Optionally, said estimating is performed using a classification algorithm.

Optionally, the classification algorithm is a supervised classification algorithm which is trained with respect to a training set.

Optionally, the training set comprises information relating to mobile devices for which demographic information relating to users using the mobile devices is obtainable from an installed application that requires a registration process or from an association with a profile of an online service.

Optionally, the list of applications that are installed on a mobile device is a partial list that excludes at least one application that is installed on the mobile device.

Optionally, the one or more demographic parameter comprises a user preference.

Another exemplary embodiment of the disclosed subject matter is a computerized apparatus having a processor, the processor being adapted to perform the steps of: obtaining a list of applications that are installed on a mobile device; and estimating, based on the list of applications, one or more demographic parameter of a user of the mobile device.

Optionally, the applications are downloadable applications, wherein the applications are listed in an electronic catalog, and wherein the electronic catalog is associated with a mobile applications repository connectable over a computerized network.

Optionally, said obtaining comprises receiving from the mobile device the list of applications.

Optionally, the processor is adapted to: obtain usage statistics associated with the applications; obtain non-application data; and wherein said estimating is further based on the usage statistics and the non-application data.

Optionally, said estimating is performed using a supervised classification algorithm which is trained with respect to a training set; wherein the training set comprises information relating to mobile devices for which demographic information relating to users using the mobile devices is obtainable from an installed application that requires a registration process or from an association with a profile of an online service.

Yet another exemplary embodiment of the disclosed subject matter is a computer-implemented method performed by a mobile device having a processing unit, said method comprising: obtaining a list of applications that are installed on said mobile device, wherein based on the list of applications, one or more demographic parameters of a user of said mobile device are determined; and performing a user engagement based on the estimated one or more demographic parameters.

Optionally, the user engagement is an advertisement serving.

Optionally, the user engagement is a User Interface manipulation.

Yet another exemplary embodiment of the disclosed subject matter is a computer program product comprising: a non-transitory computer readable medium retaining program instructions, which instructions when read by a processor of a mobile device, cause the processor to perform the steps of: obtaining a list of applications that are installed on the mobile device, wherein based on the list of applications, one or more demographic parameters of a user of said mobile device are determined; and performing a user engagement based on the estimated one or more demographic parameters.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A-1B show computerized environments, in accordance with some exemplary embodiments of the disclosed subject matter;

FIG. 2A-2B show flowchart diagrams of steps in methods, in accordance with some exemplary embodiments of the disclosed subject matter; and

FIG. 3 shows a block diagram of components of a system, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In the present disclosure a “mobile device” may be a mobile computerized platform, such as but not limited to a tablet computer, a PDA, an e-book reader, a smart phone or the like.

In the present disclosure a “demographic parameter” is any information relating to demographic information and/or user preferences, such as but not limited to gender, race, age or age group, disabilities, mobility, home ownership, employment status, location, annual income, user interests, preference regarding social activities, preferences regarding entertainment, consumption preferences, travel preferences, or the like.

One technical problem dealt with by the disclosed subject matter is to determine estimated demographic parameters of a user of a mobile device. Another problem is to estimate the demographic parameters without directly requiring the user to provide exact information. In some cases, a user may decide against providing information due to privacy issues, lack of time, or any other reason. Though information may be obtained from third-party services, such as social networks, and other online services, the user may decide against providing log-in credentials or any other personally identifiable information (such as but not limited to Unique Device Identifier (UDID)) and thus the user's data may not be accessible. It may still be desirable to estimate demographic information relating to the user even when the user does not actively cooperate with the demographic estimation process.

One technical solution is to estimate demographic parameters based on the user's usage characteristics of the mobile device. In some exemplary embodiments, the usage characteristics may be reflected in a content stored on the mobile device.

In some exemplary embodiments, the user may install apps in the mobile device. Based on demographic profiles of other users that have installed similar apps in their mobile devices, the user's demographic parameters may be estimated. In case the apps are downloaded from a shared source, such as an online repository, there is greater likelihood that other users with similar demographic characteristics would download the same applications as the user.

In some exemplary embodiments, similar apps may be identified and based on a similarity between collections of apps, similarity of the users may be determined. In some exemplary embodiments, two users which use different sets of apps may be used as a reference to one another based on the similarities between the apps that each of them use.

Additionally or alternatively, accessing the electronic catalog of the online repository may provide useful hints to demographic characteristics, such as based on a textual description of the app in the catalog, based on user-input data such as reviews, or the like. As an example only, the language of the description may hint to a nationality of the user. As another example, the wording of the description may target users of specific age, such as children. As yet another example, reviews by users may indicate names of users that have downloaded the app. From the name, the gender may be estimated.

Additionally or alternatively, usage statistics relating to the user's usage of the installed apps, such as but not limited to order of installation (e.g., which app was installed first, second, and so forth), installation time, usage count, usage time profile, or the like.

Additionally or alternatively, non-application data may be used for estimating the user's demographic parameters.

The non-application data may include information obtained from the device such as device type, locale, or the like.

The non-application data may include statistics relating to non-application content in the mobile device, such as but not limited to how many media files are contained thereon (a number or within a range), how many audio files, pictures, video clips are retained in the mobile device, time of usage of the media content, or the like.

The non-application data may include meta-data obtainable from digital files retained in the mobile device, such as but not limited to album name of an audio file, an artist name of a video clip, a geo-location tag of a picture, or the like.

The non-application data may include a number of media files retained in the mobile device.

The non-application data may include one or more types of media files retained in the mobile device. As an example only, the types may be “audio” and “image” for a mobile device which has only audio files and digital images stored thereon but no video clips.

The non-application data may include an origin of media files retained in the mobile device, such as but not limited to downloaded from a network, received from a friend, recorded by the user, or the like. It will be noted that different types of users may use a camera of the mobile device to capture images and based upon the number of such captured images, the demographic parameters may be estimated.

The non-application data may include information relating to the mobile device itself, such as but not limited to device brand, device type, mobile operator used by the mobile device, physical location of the device, locale used by the device, or the like.

Another technical solution is to utilize a machine learning based classifier to automatically classify, based on the usage characteristics, the demographic parameters of the users. The classifier may be a supervised classifier which may infer the classification function from a training dataset, such as but not limited to Support Vector Machines (SVM), decision tree learning, random forests, naïve bayes classifier, case-based reasoning, gene expression programming, or the like. Additionally or alternatively, the classifier may be an unsupervised classifier, such as but not limited to k-means clustering, mixture models clustering, hierarchical clustering, blind signal separation, or the like.

In some exemplary embodiments, a training dataset may be obtained, directly or indirectly, from mobile devices for which the users have provided, directly or indirectly, their demographic parameters. Users may provide demographic parameters, for example, by providing it explicitly to one or more apps in the mobile device, by connecting the mobile device to an account in an online service, such as a social network, an email service, an online dating service, or the like, or by similar means. In some exemplary embodiments, demographic parameters may be inferred from content of the mobile device, such as inferring gender of a user based on a profile image of the user, a nickname the user users, or the like. Data may be obtained from the mobile devices of such users in addition to the demographic information and be used as a training dataset for a supervised classifier.

In some exemplary embodiments, training dataset may be received from users after an initial training The training dataset may be updated data, such as based on modifications in the content of the mobile device and usage thereof. Additionally or alternatively, the training dataset may also include information regarding users that were not previously available.

Yet another technical solution is to periodically update estimated demographic parameters based on the usage characterization of the mobile device, thereby enabling detection of a user change and of better estimation. In some exemplary embodiments, the estimated data may be recomputed once every predetermined period. Additionally or alternatively, the estimated data may be recomputed every time that the estimated data is to be used.

In some exemplary embodiments, the training dataset may be periodically or continuously updated.

One technical effect is an anonymous estimation of demographic parameters of users. Additionally or alternatively, the estimation can be performed without user assistance or awareness. The user may not object to the demographic estimation due to privacy issues as the user may be unaware of the estimation process.

Another technical effect is exploiting common source of obtaining apps for the mobile device to compare, based on the sub-portion of the available apps, apps preference of different users and thereby determine implicit demographic profiles based on the portion of the apps downloaded by the users.

Yet another technical effect is to enable mobile apps, mobile operators, application repositories and similar parties to estimate demographic parameters of users of mobile devices and to use the demographic parameters for user engagement.

In some exemplary embodiments, an estimation may be accompanied by an “accuracy” indication, such as a number between 0 and 1 indicating an estimated probability that the estimation is correct. The accuracy indication may also be referred to as confidence measurement, and may be used to determine, automatically or manually or in combination thereof, whether to use the estimation with respect to a specific user. For example, estimation that is below a certain threshold, such as below 25%, may not be used. The accuracy indication may be provided by a demographic estimator.

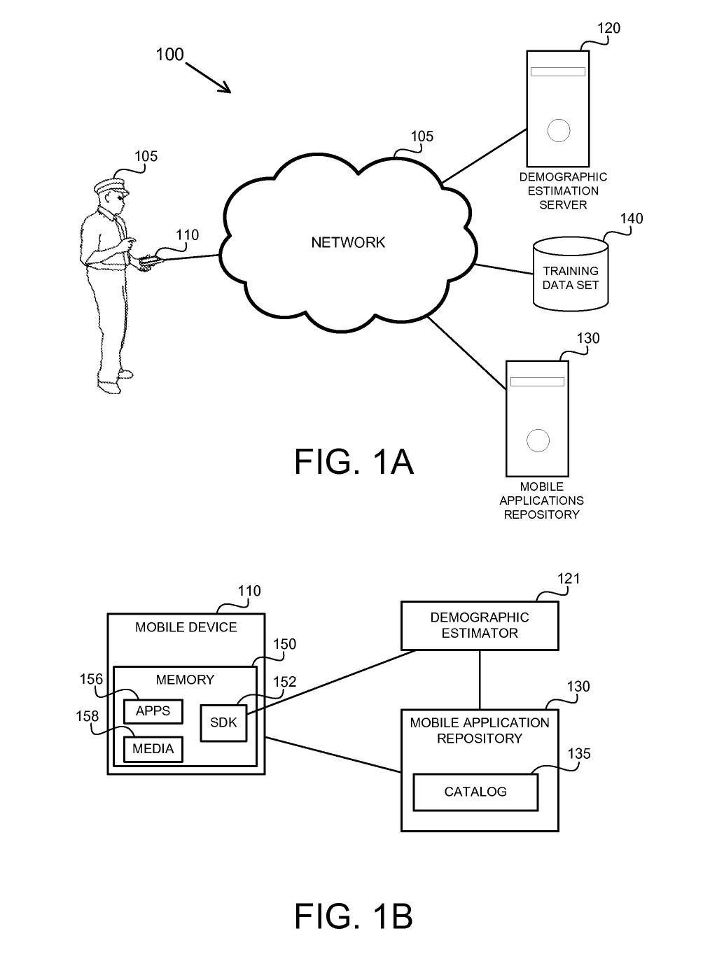

Referring now to FIG. 1A showing a Computerized Environment 100 of some exemplary embodiments of the disclosed subject matter.

A Mobile Device 110 may be used by a User 105. Mobile Device 110 may be connectable to a Network 105, such as but not limited to LAN, WAN, Wi-Fi network, intranet, Internet, or the like.

Demographic Estimation Server (DES) 120 may be a computerized platform comprising a processing unit. DES 120 may be connectable to Network 105. DES 120 may receive information from Mobile Device 110 and based thereof estimate demographic parameters of User 105. Mobile Device 110 may transmit over Network 105 information useful for characterizing the usage of Mobile Device 110 by User 105, such as but not limited to: installed applications on the Mobile Device 110, non-application data, application usage statistics (e.g., installation time, usage count of each application, last usage time of each application, etc.), or the like. In some exemplary embodiments, DES 120 may also be executed entirely on Mobile Device 110.

In some exemplary embodiments, DES 120 may use a classifier (not shown) which may utilize a machine learning classification algorithm to estimate demographic parameters. The classifier may be training using Training Data Set 140 which may be retained in DES 120 or in a separate platform. In some exemplary embodiments, Training Data Set 140 may be obtained from mobile devices such as 110 for which at least one demographic parameter of the user is known. In some exemplary embodiments, Training Data Set 140 may be continuously updated and DES 120 may be repeatedly trained with the updated data.

In some exemplary embodiments, the applications installed in Mobile Device 110 may be downloadable via Network 105 from a Mobile Application Repository 130. It will be understood that a plurality of different and separate repositories may exist, but they may all be referred to together as Mobile Application Repository 130.

In some exemplary embodiments, Repository 130 may comprise an electronic catalog listing downloadable applications including at least a portion of the applications installed in Mobile Device 110. The electronic catalog may comprise meta information regarding the applications, such as but not limited to reviews thereof by users, a download count, descriptive text, available UI languages, or the like. The catalog information may be used by the DES 120 to estimate the demographic parameters. In some exemplary embodiments, using catalog information, demographic parameters may be estimated with respect to an application installed in Mobile Device 110 but in no other mobile device for which there is information in Training Data Set 140. For example, based on user reviews it may be differed by the classifier that application is used mostly be people of certain age, gender, ethnicity, or the like.

Referring now to FIG. 1B, Mobile Device 110 comprises an electronic Memory 150. Memory 150 retains installed Apps 156, and other content, such as Media 158. Software Development Kit (SDK) 152 may be a computer program product configured to be installed on a mobile device. SDK 152 may be installed in Mobile Device 110 as part of an application, such as downloadable from Mobile Application Repository 130. In some exemplary embodiments, SDK 152 may be a stand-alone computer program product which is not integrated with another app.

SDK 152 may be configured to identify installed Apps 156 in Mobile Device 110. In some exemplary embodiments, SDK 152 may obtain a partial list of applications installed on Mobile Device 110. Additionally or alternatively, SDK 152 may be configured to obtain usage statistics relating to Apps 156. Additionally or alternatively, SDK 152 may be configured to identify non-application information in Mobile Device 110 such as Media 158 and origin thereof.

SDK 152 may be configured to provide Demographic Estimator 121 with the information collected from Mobile Device 110. In some exemplary embodiments, Demographic Estimator 121 may be installed on Mobile Device 110, may be installed on a remote server, such as DES 120, or be otherwise remotely located from Mobile Device 110 may operatively coupled to SDK 152.

Demographic Estimator 121 may be configured to utilize a classifier to determine, based on the information provided by SDK 152, estimated demographic parameters of User 105. In some exemplary embodiments, Demographic Estimator 121 may further base its determination on information obtainable from Mobile Application Repository 130, such as but not limited to content of electronic Catalog 135 that is associated with Apps 156.

In some exemplary embodiments, Demographic Estimator 121 may be configured to utilize training data obtained from other mobile devices to train the classifier. SDK 152 may be installed on such mobile devices and used to obtain also information regarding the demographic parameters of the users using the mobile devices, such as based on a connection to an online service, based on user input to SDK 152 or to another application installed on the mobile device, or the like.

In some exemplary embodiments, Mobile Device 110 may not include SDK 152 or similar computer program product. DES 120 may receive a list of installed applications from another server, and optionally other information collected from Mobile Device 110. The information collected from Mobile Device 110, including but not limited to a list of installed apps, may be partial or not up-to-date, such as when the information has been collected in the past, the information is collected not directly from the Mobile Device 110, or the like.

In some exemplary embodiments, the list of apps may be a list of apps that use a third-party's ad-serving computer product. The add-serving computer product may report that each such app is installed on Mobile Device 110 and the information may be retained with respect to each Mobile Device 110 in a database (not shown). The information may later be provided to DES 120 which may provide estimated demographic parameters, such as to be used for targeted ad-serving. Additionally or alternatively, an ad serving network may collect apps profile of each user in the network from other sources.

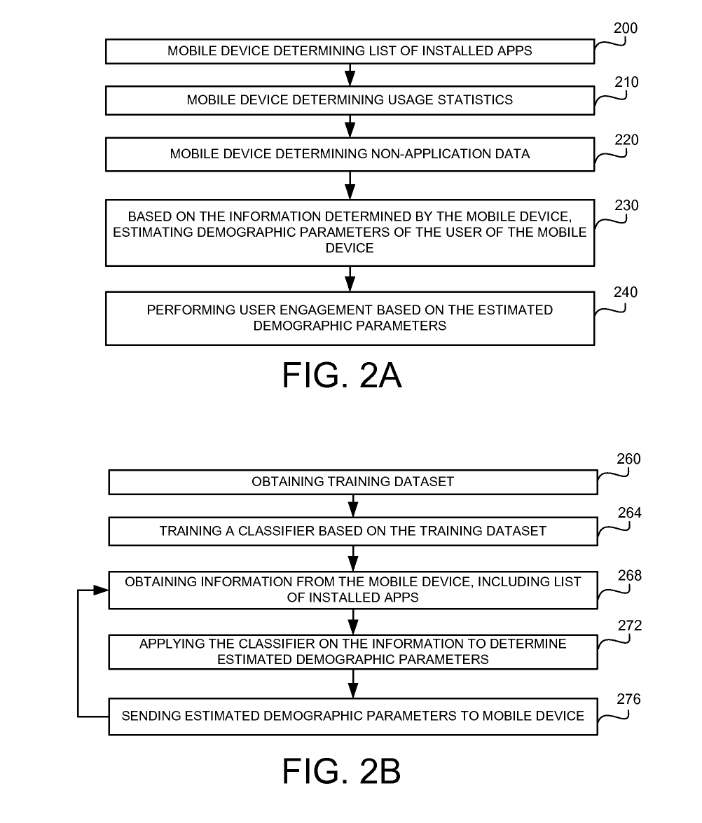

Referring now to FIG. 2A showing a method in accordance with some exemplary embodiment of the disclosed subject matter.

In Step 200, the mobile device may determine a list of installed applications in the mobile device. In some exemplary embodiments, the list of installed applications may be determined based on a memory snapshot of the mobile device, based on installed apps recognized by the operating system of the mobile device, or the like. It will be understood that the list of installed applications may be partial and not necessarily complete. A partial set of the installed applications may be obtained and used.

In Step 210, the mobile device may determine usage statistics associated with the installed applications.

In Step 220, the mobile device may determine non-application data of the mobile device.

In some exemplary embodiments, Steps 200-220 may be performed by an SDK installed in the mobile device, such as SDK 152.

In Step 230, demographic parameters of a user using the mobile device may be estimated based on the information determined in Steps 200-220 or portion thereof. The estimation may be performed by the mobile device, such as by a classifier executed by the mobile device. Additionally or alternatively, the estimation may be performed off the mobile device, such as in a remote server (e.g., DES 120), or the like.

In Step 240, a user engagement may be performed based on the estimated demographic parameters. The user engagement may be, for example, providing the mobile device with targeted content (e.g., advertisement serving); UI manipulation by the mobile device, content filtering by the mobile device or by a server providing the content thereto; or the like.

Referring now to FIG. 2B showing a method in accordance with some exemplary embodiment of the disclosed subject matter.

In Step 260, a training dataset is obtained. The training dataset may be obtained from mobile devices for which users' demographic parameters are explicitly or implicitly provided, and for which information such as obtained in Steps 200-220 may be obtained.

In Step 264, a classifier may be trained based on the training dataset.

In Step 268, information may be obtained from the mobile device, including a list of applications installed thereon.

In Step 272, the classifier may be utilized. The classification algorithm may be applied based on the information to determine estimated demographic parameters of the user.

In Step 276, the estimated demographic parameters may be sent to the mobile device to be used by programs installed thereon. Additionally or alternatively, the information may be sent to another server or a remote computing platform that is configured to utilize the demographic parameters, such as for configuring user engagement.

Steps 268-276 may be performed iteratively with respect to a plurality of mobile devices. In some exemplary embodiments, Steps 268-276 may be performed a plurality of times with respect to the same mobile device. As one example, Steps 268-276 may be performed on-demand (i.e., when the estimated information is required or desired). As another example, Steps 268-276 may be performed periodically to be able to identify modifications to the demographic parameters (e.g., the user has aged, relocated, or the like).

In some exemplary embodiments, the one or more last estimated demographic parameters may be used in estimating the current demographic parameters, thereby allowing to take into account historic information to determine current information. As an example, previous age group may be used to assist in estimating that a user who was of the age group 10-14 is now in the age group of 15-18 and not in the age group 50-60.

In some exemplary embodiments, training dataset may be continuously updated and the classifier may be re-trained in accordance thereof, such as enabling identification of information relating to trends and the passage of time.

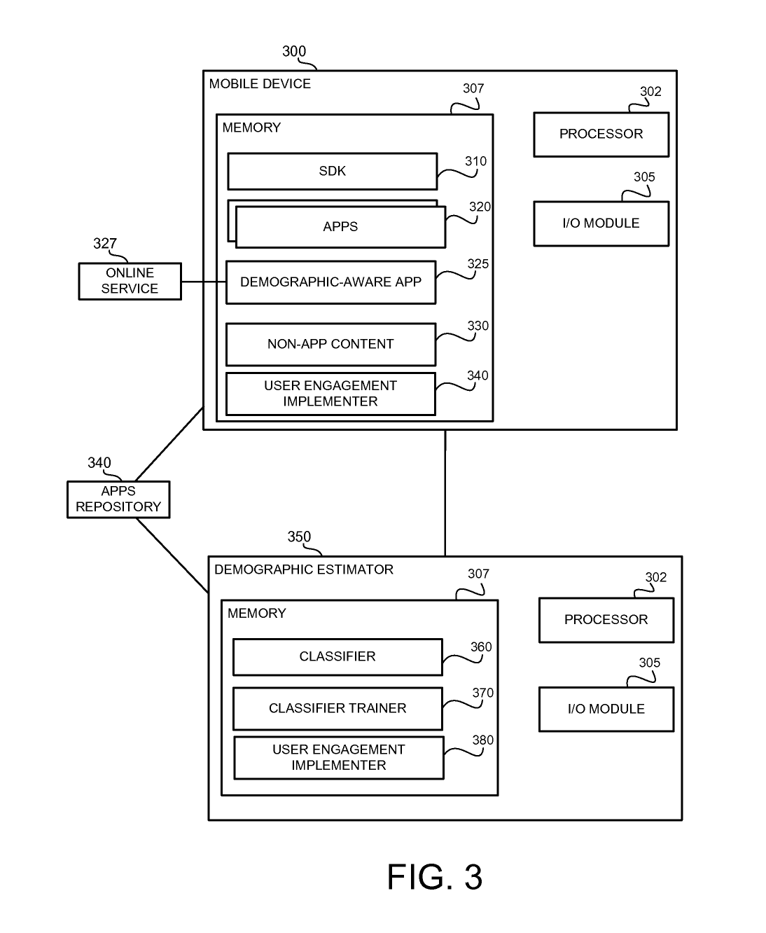

Referring now to FIG. 3 showing a block diagram of a system, in accordance with some exemplary embodiments of the disclosed subject matter. The system may comprise a Mobile Device 300, such as 110 of FIG. 1A.

Mobile Device 300 may comprise a Processor 302. Processor 302 may be a Central Processing Unit (CPU), a microprocessor, an electronic circuit, an Integrated Circuit (IC), a Digital Signal Processor (DSP), a microcontrollers, a Field Programmable Gate Array (FPGA) or Application Specific Integrated Circuit (ASIC). Processor 302 may be utilized to perform computations useful for Mobile Device 300 or any of it subcomponents.

In some exemplary embodiments of the disclosed subject matter, Mobile Device 300 may comprise an Input/Output (I/O) module 305. The I/O module 305 may be utilized to provide an output to and receive input from a user, such as 105 of FIG. 1. In some exemplary embodiments, I/O Module 305 may be utilized to connect to other computing platforms, such as via a computerized network.

In some exemplary embodiments, Mobile Device 300 may comprise a Memory 307. Memory 307 may be persistent or volatile. For example, Memory 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory 307 may retain program code operative to cause Processor 302 to perform acts associated with any of the subcomponents of Mobile Device 300.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

SDK 310, such as 152 of FIG. 1B, may be configured to obtain information useful for estimating demographic parameters of the user. In some exemplary embodiments, SDK 310 may be further configured to obtain demographic parameters when available and providing them together with the information as part of a training data set.

Apps 320, such as 156 of FIG. 1B, may be installed on Mobile Device 300. In some exemplary embodiments, Apps 320 or portion thereof may have been downloaded from an Apps Repository 340, such as 130 of FIG. 1B.

In some exemplary embodiments, Apps 320 may comprise one or more Demographic-Aware App 325 which may be aware of at least some of the user's demographic parameters. Demographic-Aware App 325 may obtain the demographic information by receiving input from the user, by obtaining it from Online Service 327, such as a social network, an email service, or the like, or from other sources.

In some exemplary embodiments, Non-App Content 330 may be retained in Memory 307, such as but not limited to Media 158.

SDK 310 may be configured to obtain the information useful for demographic estimation from Memory 307, such as a list of installed apps (Apps 320), characterization of use of Apps 320, Non-App Content (e.g., media files) and characterization thereof, or the like.

A Demographic Estimator 350 which may be implemented on Mobile Device 300 or may be implemented on an alternative computing platform having components such as Memory 307, Processor 302 and I/O Module 305. Demographic Estimator 350 may be operatively coupled to SDK 310.

Demographic Estimator 350 may comprise a Classifier 360 which may be configured to classify, based on the information obtained by SDK 310, estimated demographic parameters of a user of Mobile Device 300. In some exemplary embodiments, Classifier 360 may be trained by a Classifier Trainer 370 which may utilize a training data set. In some exemplary embodiments, The training data set may be obtained from mobile devices in which SDK 310 is installed and for which Demographic-Aware App 325 is available or the demographic information is available from another source.

In some exemplary embodiments, Classifier 360 may utilize Apps Repository 340 and electronic catalog thereof in estimating demographic parameters associated with Apps 320 or portion thereof for which an entry in the catalog exists.

Additionally or alternatively, meta information regarding applications may be obtained from other sources, such as but not limited to tags obtainable from HTML5-implemented applications. The meta information may be useful in identifying similarities between different applications, such as determining that two different applications of a Tetris game are similar, or determining that two different word processing applications are similar, or the like.

Based on the estimated demographic information User Engagement Implementer 380 may be configured to implement a demographic-aware user engagement. User Engagement Implementer 380 may be comprised by Demographic Estimator 350, by a different computing platform, such as a Content Delivery Network (CDN) Server, an Ad Server, or the like, or by Mobile Device 300.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a processing unit, said method comprising:
obtaining a list of applications that are installed on a mobile device; and
estimating, based on the list of applications, one or more demographic parameter of a user of the mobile device.

2. The computer-implemented method of claim 1, wherein the applications are downloadable applications, and wherein the applications are listed in an electronic catalog.

3. The computer-implemented method of claim 2, wherein the electronic catalog is associated with a mobile applications repository connectable over a computerized network.

4. The computer-implemented method of claim 1, wherein said obtaining comprises receiving from the mobile device the list of applications, and wherein said estimating is performed by a server comprising said processing unit, wherein the server is connectable via a network to the mobile device.

5. The computer-implemented method of claim 1 further comprises obtaining usage statistics associated with the applications, and wherein said estimating is further based on the usage statistics.

6. The computer-implemented method of claim 5, wherein the usage statistics comprising at least one of the following information:
installation time;
order of installation;
usage count; and
last usage time.

7. The computer-implemented method of claim 1 further comprises obtaining non-application data, and wherein said estimating is further based on the non-application data.

8. The computer-implemented method of claim 7, wherein the non-application data comprises at least one of the following items:
statistics relating to non-application content in the mobile device;
meta-data obtainable from digital files retained in the mobile device;
a number of media files retained in the mobile device;
one or more types of media files retained in the mobile device;
origin of media files retained in the mobile device; and
information relating to the mobile device.

9. The computer-implemented method of claim 1, wherein said estimating is performed using a classification algorithm.

10. The computer-implemented method of claim 9, wherein the classification algorithm is a supervised classification algorithm which is trained with respect to a training set.

11. The computer-implemented method of claim 10, wherein the training set comprises information relating to mobile devices for which demographic information relating to users using the mobile devices is obtainable from an installed application that requires a registration process or from an association with a profile of an online service.

12. The computer-implemented method of claim 1, wherein the list of applications that are installed on a mobile device is a partial list that excludes at least one application that is installed on the mobile device.

13. The computer-implemented method of claim 1, wherein the one or more demographic parameter comprises a user preference.

14. A computerized apparatus having a processor, the processor being adapted to perform the steps of:
obtaining a list of applications that are installed on a mobile device; and
estimating, based on the list of applications, one or more demographic parameter of a user of the mobile device.

15. The apparatus of claim 14, wherein the applications are downloadable applications, wherein the applications are listed in an electronic catalog, and wherein the electronic catalog is associated with a mobile applications repository connectable over a computerized network.

16. The apparatus of claim 14, wherein said obtaining comprises receiving from the mobile device the list of applications.

17. The apparatus of claim 14, wherein the processor is adapted to:
obtain usage statistics associated with the applications;
obtain non-application data; and
wherein said estimating is further based on the usage statistics and the non-application data.

18. The apparatus of claim 14, wherein said estimating is performed using a supervised classification algorithm which is trained with respect to a training set; wherein the training set comprises information relating to mobile devices for which demographic information relating to users using the mobile devices is obtainable from an installed application that requires a registration process or from an association with a profile of an online service.

19. A computer-implemented method performed by a mobile device having a processing unit, said method comprising:
obtaining a list of applications that are installed on said mobile device, wherein based on the list of applications, one or more demographic parameters of a user of said mobile device are determined; and
performing a user engagement based on the estimated one or more demographic parameters.

20. The computer-implemented method of claim 19, wherein the user engagement is an advertisement serving.

21. The computer-implemented method of claim 19, wherein the user engagement is a User Interface manipulation.

22. A computer program product comprising:
a non-transitory computer readable medium retaining program instructions, which instructions when read by a processor of a mobile device, cause the processor to perform the steps of:
obtaining a list of applications that are installed on the mobile device, wherein based on the list of applications, one or more demographic parameters of a user of said mobile device are determined; and
performing a user engagement based on the estimated one or more demographic parameters.
